(19) United States
(12) Patent Application Publication
(10) Pub. No.: US 2009/0312107 A1
(43) Pub. Date: Dec. 17, 2009

(54) Drive Plate for a Coupling Device, Especially a Hydrodynamic Torque Converter

(75) Inventor: Michael Scordino, Canton, MI (US)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/486,107

(22) Filed: Jun. 17, 2009

Related U.S. Application Data
(60) Provisional application No. 61/073,168, filed on Jun. 17, 2008.

(30) Foreign Application Priority Data
Jun. 27, 2008 (DE) 10 2008 002 710.3

(51) Int. Cl. F16D 3/00

(52) U.S. Cl. 464/98

(57) ABSTRACT

A drive plate for a coupling device, especially a hydrodynamic torque converter, for connecting a housing of the coupling device to a drive element includes a drive plate body designed as a formed metal part, where a bearing projection extending more-or-less in the direction parallel to an axis of rotation is formed on the radially inner area of the drive plate body.

### RELATED APPLICATIONS

This application claims priority from U.S. Provisional Patent Application Ser. No. 61/073,168 which was filed on Jun. 17, 2008 and German Application No. 10 2008 002 710.3 which was filed on Jun. 27, 2008.

### BACKGROUND OF THE INVENTION

1. Field of the Invention

The present invention pertains to a drive plate for a coupling device such as a hydrodynamic torque converter. By means of this drive plate, the housing of a coupling device of this type can be connected to a drive element. A drive element of this type can be, for example, a so-called flexplate, the radially inner part of which is connected for rotation in common around an axis of rotation to a drive shaft, such as the crankshaft of an internal combustion engine, whereas the radially outer part can be connected by screw joints to the drive plate.

2. Description of the Related Art

So that coupling devices such as hydrodynamic torque converters can be connected to a drive shaft such as the crankshaft of an internal combustion engine, it is known that metal parts provided with threads can be welded to the outside surface of the housing of a coupling device of this type. Fastening screws can then be screwed into these threads to fasten the radially outer area of a flexplate, for example, or some other type of coupling plate to the housing. It is also known that, to center a coupling device of this type on the drive shaft, i.e., to achieve a coaxial alignment, a bearing projection, for example, can be welded to the central area of the housing. This bearing projection engages in a bearing recess in a drive shaft and thus guarantees that the coupling device is coaxially aligned with the drive shaft.

### SUMMARY OF THE INVENTION

An object of the present invention is to provide a drive plate for a coupling device, especially a hydrodynamic torque converter, namely, a drive plate which is of simplified design but which also makes it possible to improve the functionality of the coupling device.

According to the invention, the drive plate has a drive plate body designed as a formed metal part, with a bearing projection extending more-or-less in the direction parallel to the axis of rotation formed on the radially inner area of the drive plate body.

The drive plate of the inventive design is produced as a formed sheet metal part, for example, and has a bearing projection as an integral part in its radially inner area. This projection is formed on the drive plate at the same time that the drive plate itself is formed. A highly stable arrangement is thus created in this way by the forming process. At the same time, there is no longer any need to provide a bearing projection of this type on the coupling device. This makes it possible to produce the housing of the coupling device out of a material which is optimized to meet the requirements in the area of the coupling device without making it necessary to take into account the need to provide a bearing projection.

So that the drive plate can be connected to the drive element, the radially outer area of the drive plate body can be provided with a first coupling formation for connecting the drive plate to the drive element.

So that the drive plate can be connected to the housing of a coupling device, the drive plate body can have a second coupling formation, which is located radially between the first coupling formation and the bearing projection, and which serves to connect the plate to the housing of the coupling device.

The bearing projection is preferably designed with a tubular shape, and it can have a bearing bead on its free end surface to provide a bearing surface, which can then rest with a centering effect against a corresponding surface of the bearing recess.

The present invention also pertains to a coupling device, especially a hydrodynamic torque converter, including a housing and a drive plate of inventive design attached to this housing.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a partial longitudinal cross section through an inventively designed drive plate; and

FIG. 2 shows the drive plate fixed to the housing of a torque converter, and a flex plate fixed to a drive shaft.

### DETAILED DESCRIPTION OF THE PRESENTLY PREFERRED EMBODIMENTS

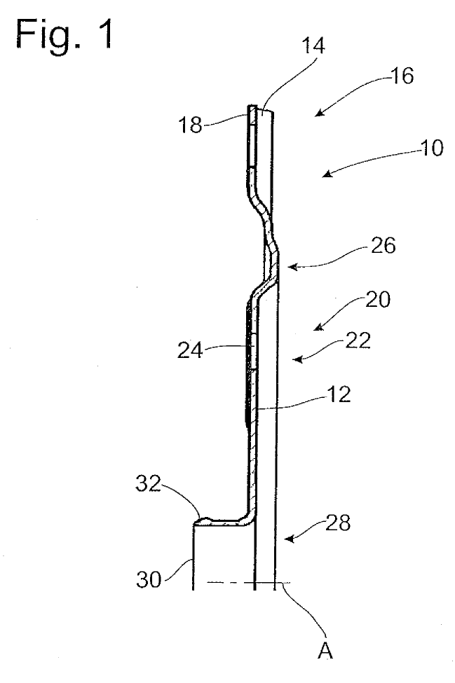

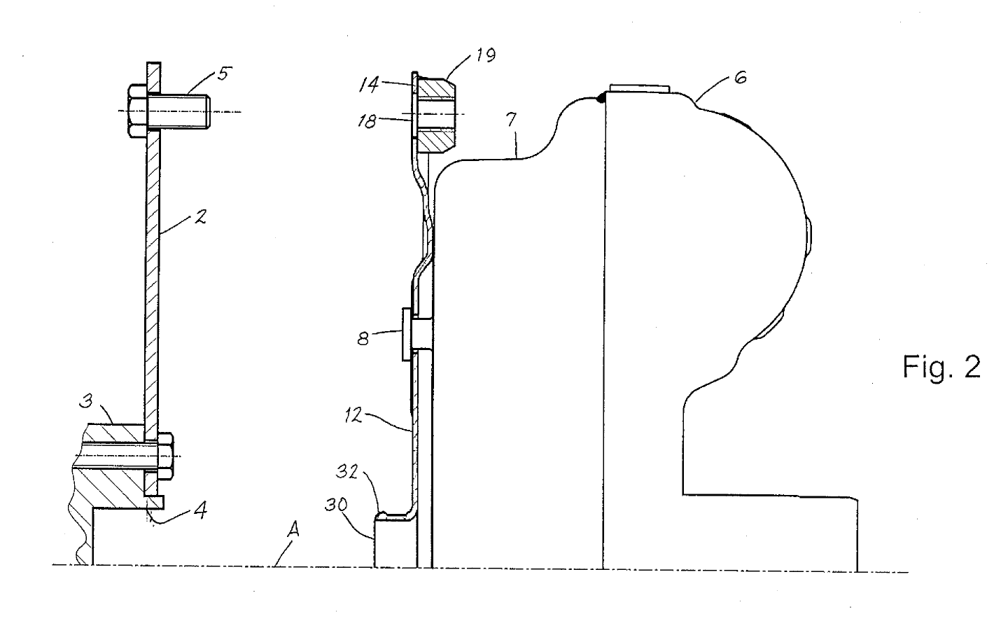

The drive plate 10 has an essentially ring-shaped contour and includes a drive plate body 12. In its radially outer area, this body has axial elevations 14 distributed around an axis of rotation A in a plurality of circumferential positions to form a first coupling formation 16. These axial elevations 14 are open radially toward the outside, and each has a hole 18. In the area of this type of axial elevation 14, a threaded fastening element can be provided on the side facing the coupling device and facing away from the drive unit, that is, on the side which appears on the right in FIG. 1. This fastening element can be, for example, an internally threaded element 19, into which a bolt element 5 can be screwed to connect the drive plate 10 to a flexplate 2 or the like fixed to a drive shaft 3 and acting as a drive element (see FIG. 2). In its radially middle area 20, the drive plate 10 has a second coupling formation 22, also having a plurality of holes 24 arranged in a circumferential row around the axis of rotation A. Rivet projections 8 provided as integral parts of the housing 7 of the coupling device 6, for example, can be passed through these holes 24 and deformed to grip the drive plate 10 from behind, so that a permanent connection is established. Between the holes 18 and the holes 24, in the radially middle area 20, the drive plate 10 is designed with an essentially ring-like axial elevation 26, which increases the overall rigidity and stability.

In the radially inner area 28, a bearing projection 30 formed as an integral part of the drive plate body 12. This projection extends axially away from the coupling device to be connected to the drive plate 10 and toward a drive unit or its drive shaft. The bearing projection 30 has a tubular shape and has in its free end area a bearing bead 32, which, for example, is produced by displacing material from the essentially cylindrical area of the bearing projection 30 toward the free end area. The bearing bead 32 is provided with a feed bevel, which makes it easier to introduce the bearing projection into a bearing recess 4 designed to accept it. At the same time, the ring-like outer circumferential surface of the bearing bead provides a bearing surface, which can rest against an inner circumferential surface of the bearing recess, possibly formed on a friction bearing element.

As a result of the design of the drive plate 10 as a formed metal part with the two coupling formations and the bearing projection on the drive plate body, the cost-saving possibility is obtained of centering the drive plate 10 and thus also the coupling device connected permanently to it on a drive shaft. Because there is no longer any need to accomplish this centering by means of an element provided directly on the coupling device itself, it is possible to produce the housing of the coupling device, that is, for example, the housing of a hydrodynamic torque converter, out of a material or with a thickness of material which might be less suitable than it otherwise could be for the attachment of a bearing projection but which makes it possible to improve the functionality in the area of the coupling device itself. In particular, it thus becomes possible to increase the overall rigidity of the assembly including the drive plate on one side and the housing on the other side. The amount of material which is wasted during the production of the drive plate itself is also reduced, because the radially inner area, which would otherwise be stamped out and thrown away, for example, is used to produce the bearing projection.

Another advantage of the use of a drive plate designed as a formed metal part in comparison to fastening arrangements in which metal parts provided with threaded elements are welded to the outside surface of the housing of the coupling device is that, as a result of the elimination of this additional attachment process involving a joining of materials, the danger of causing deformations to the housing can be reduced.

The invention is not limited by the embodiments described above which are presented as examples only but can be modified in various ways within the scope of protection defined by the appended patent claims.

We claim:

1. A drive plate for connecting the housing of a coupling device to a drive element, wherein the drive plate comprises a substantially disk-shaped drive plate body having a radially outer area, a radially inner area, and a central axis of rotation, the plate body being formed from sheet metal and comprising a tubular bearing projection formed on the radially inner area and extending coaxially to the axis of rotation.

2. The drive plate of claim 1 further comprising a first coupling formation in the radially outer area for connecting to a drive element.

3. The drive plate of claim 2 further comprising a second coupling formation radially between the first coupling formation and the bearing projection for connecting to the housing of a coupling device.

4. The drive plate of claim 3 further comprising a ring-like axial elevation extending around the plate body between the first and second coupling formations.

5. The drive plate of claim 1 wherein the bearing projection is substantially cylindrical.

6. The drive plate of claim 1 wherein the bearing projection has a free end provided with a bearing bead.
